(19) United States
(12) Patent Application Publication
(10) Pub. No.: US 2016/0097338 A1
(43) Pub. Date: Apr. 7, 2016

(54) METHOD FOR OPERATING AN INTERNAL COMBUSTION ENGINE

(71) Applicant: GE Jenbacher GmbH & Co OG, Jenbach (AT)

(72) Inventors: Friedrich GRUBER, Hippach (AT); Nikolaus SPYRA, Innsbruck (AT); Christian TRAPP, Hall in Tirol (AT); Georg TINSCHMANN, Schwaz (AT); Ettore MUSU, Modena (IT)

(21) Appl. No.: 14/858,474

(22) Filed: Sep. 18, 2015

(30) Foreign Application Priority Data
Oct. 6, 2014 (AT) A 50714/2014

(51) Int. Cl. F02D 41/30; F02D 19/10; F02D 19/06; F02B 1/14; F02B 7/04

(52) U.S. Cl. CPC F02D 41/3047; F02B 1/14; F02B 7/04; F02D 19/0647; F02D 19/105; F02D 41/3094

(57) ABSTRACT

A method of operating a compression ignition engine uses an engine having a cylinder and a piston moveable in the cylinder. The method includes forming a combustible mixture by mixing generally homogeneously a first fuel and air and introducing this mixture into the at least one cylinder, and compressing the combustible mixture with the piston in a compression stroke. During the compression stroke but before start of combustion, a second fuel is added to the combustible mixture, thus creating a cylinder charge, the second fuel being easier to autoignite than the first fuel. The compression stroke is continued until combustion starts at those locations in the cylinder where concentration of the second fuel and/or temperature of the mixture is highest. A temperature of the cylinder charge and/or the amount of second fuel added to the combustible mixture is chosen such that a desired duration of combustion can be achieved.

The present invention is directed to a method for operating an internal combustion engine with the features of the preamble of claim 1 and to an internal combustion engine with the features of the preamble of claim 10.

When designing internal combustion engines there are conflicting requirements between the reduction of different types of emissions like nitrogen oxides (NOx), unburnt hydrocarbons (HC), carbon monoxide (CO) and the reduction of particulate matters (PM). A promising approach to realize highly efficient and low emission combustion is the HCCI-concept (homogeneous charge compression ignition). Here, the ignition of a highly diluted (lean and/or with high rate of exhaust recirculation, EGR) and homogeneous fuel-air-mixture is effected through the temperature increase during the compression stroke close to the upper dead center of the piston. The very dilute fuel-air-mixture allows combustion with extremely low values for nitrogen oxides (NOx).

Auto-ignition of the fuel-air-mixture in the combustion chamber is achieved through a combination of various measures, as for example a high geometric compression ratio ε and pre-heating of the charge through suitable measures (for example pre-heating of the intake air or exhaust gas recirculation, EGR). As according to the HCCI combustion concept the fuel-air-mixture ignites more or less simultaneously in the whole combustion chamber close to top dead center, the combustion event is extremely rapid.

In Diesel-engines, the ignition time can be easily controlled by the injection time. The control of the ignition time in a HCCI-engine is very demanding.

It is known from the art to ignite the lean and homogeneous fuel-air-mixture through injection of a small amount of a second fuel which tends to autoignite earlier than the first fuel. The choice of start of injection of this secondary fuel can take into account the actual operating condition of the engine. With increasing load of the engine the amount of the secondary fuel is adjusted.

This concept is known as dual fuel combustion. If the second fuel is injected early and partly pre-mixed for low emissions, this concept is known as dual fuel PCCI or RCCI combustion. If the second fuel is injected in a way that both fuels are mixed homogenously, the concept is known as dual-fuel-HCCI.

The combination of two fuels with different auto-ignition properties allows a much better control of the combustion process. Without such second fuel with different auto-ignition properties, the ignition time can be adjusted through the EGR-rate, that is the percentage amount of recirculated exhaust gas. However, the variation of the external EGR-rate is not a measure with rapid effect, but shows a delayed response.

All known PCCI, HCCI, and RCCI and dual fuel concepts are associated with high HC and CO emissions, as it is well known from literature.

U.S. Pat. No. 6,659,071 shows an internal combustion engine, which can be operated in a PCCI (premixed charged compression ignition) mode, wherein a mixing device forms a mixture of a first fuel with the intake air, a fuel injection device, which is capable of injecting a second fuel directly into the combustion chamber, and a control system, which controls the injection of the second fuel in such manner, that prior to auto-ignition through the compression of the charge at least one “control injection” takes place. According to U.S. Pat. No. 6,659,071 it can be foreseen that the main fuel is natural gas and the second fuel is Diesel.

From WO 98/07973 a method to control a PCCI-engine is known, wherein the control of the combustion progress is conducted through measuring an operating state of the engine, which is indicative for the combustion progress. In order to control the start of combustion precisely, the temperature, the pressure, the equivalence ratio and or the auto-ignition properties of the fuel-air-mixture are controlled. Further it is described, to control the start of ignition and the velocity of ignition in such way, that basically the complete combustion event takes place within certain crank angle limits, in particular between 20° before the upper dead center through 35° after the upper dead center. This is based on the fact, that the point in time for the beginning of the ignition and the velocity of combustion in a PCCI-engine are depending on the behaviour of temperature, the behaviour of pressure, the auto-ignition properties of the fuel, for example the octane or methane number or the activation energy and the composition of the charge air in cylinder (oxygen content, EGR, moisture, equivalence ratio etc.)

U.S. Pat. No. 6,463,907 shows a HCCI-engine and a method to operate such engine, wherein through addition of a secondary fuel, preferably Diesel, the center of combustion is tuned to the preferred crank angle. The desired combustion delay hereby is independent from the combustion duration of the main fuel mixture, which in turn is defined by the EGR rate in connection with the air to fuel ratio. Through the addition of the secondary fuel the crank angle range, in which combustion takes place, now can be held constant through a wide range of engine speeds. Because of the relatively low burn rates of natural gas after ignition, relatively low EGR rates and high boost pressures are used. Power and speed of subject HCCI-engine are controlled through the air-fuel-mixture or boost pressure.

Also known are approaches to define the ignition timing through the external EGR rate. At high rates of recirculated exhaust gas the burn rate is slowed down because of the reduced oxygen content.

The control strategy for dual-fuel HCCI engines according to U.S. Pat. No. 6,463,907 is to effect the timing of the spontaneous ignition (auto-ignition) through injection of a fuel with high cetane number, typically diesel, prior to or early in the compression phase. The amount of fuel with high cetane number added depends on the engine speed and power and is chosen such that the ignition time is tuned to a suitable crank angle position. The combustion duration is controlled independently through the EGR rate.

To summarize, the conditions for auto-ignition of a lean homogeneous fuel-air-mixture according to the state of the art are controlled by high EGR rates, cooling of the recirculated exhaust, and high geometric compression ratios.

The shortcoming of the solutions of the state of the art is that through the high geometric compression ratio ε a very rapid increase in temperature is given accompanied by a rapid cooling after ignition through the expansion in the combustion chamber.

It is the objective of present invention to disclose a method and a combustion engine which allows a better control over the combustion event.

This object is accomplished by a method according to claim 1 and a combustion engine according to claim 10. Further preferred embodiments are described in the dependent claims.

The cylinder charge is composed of first fuel, second fuel, air and any residual gas present from previous cycles and possibly any gas added by external exhaust gas recirculation.

In the design of every compression ignition engine there is a number of boundary conditions such as mechanical stress limits and power requirements which dictate engine parameters such as geometric compression ratio. The invention is based on the surprising finding that by varying a temperature of the cylinder charge or the amount of the second fuel or a combination of both measures, the duration of combustion can be controlled in a way that raw emissions are very low and at the same time efficiency of the engine is high.

The inlet temperature of the fuel-air-mixture can be influenced through intervention on the charge air cooler and/or changes of the EGR rate.

With respect to emissions it can be noted that according to the inventive method:
NOx emissions are very low because a very high air-fuel-ratio (very lean mixture) can be used which would not be possible in a spark-ignited engine, for example. It is also important that both the first and the second fuel are pre-mixed with air or cylinder charge.
CO and HC emissions are low because combustion is fast and finishes close to the top dead center and temperature of the cylinder charge is high.
Soot emissions are low because both the first and the second fuel are pre-mixed with air or cylinder charge.

As stated above efficiency of the engine is surprisingly high in combination with reduction of all the pollutant emissions namely NOx, soot, CO and HC. All the prior art solutions allows only to achieve some of the results. For example HCCI combustion allows to reduce NOx and soot but it is associated with higher HC and CO.

The benefits of the present invention seem to be due to the fact that the duration of combustion is much shorter than in the prior art for very lean mixtures. This combination is not achieved in the prior art. It is well-known that a fast combustion in connection with a lean mixture gives high efficiency.

As already stated by choosing a temperature of the cylinder charge the invention provides the possibility to influence the duration of combustion. By adding the second fuel at a time during the compression stroke but before start of combustion the second fuel will be inhomogeneously present in the combustible mixture of first fuel and air. In other words, there will be locations in the cylinder where concentration and/or temperature of the second fuel are higher than elsewhere in the cylinder. This inhomogeneity will determine the starting point of the autoignition in the compression stroke. By choosing a higher temperature of the cylinder charge the duration of combustion can be shortened thus producing less unburnt hydrocarbons and CO and resulting in a higher efficiency of the engine. Thus the invention combines low emission with a high efficiency.

One should note that due to the small amounts of added second fuel the temperature of the second fuel has a minor influence only while the chemical energy of the second fuel has a dominant effect.

In the following the terms “duration of combustion” and “center of gravity” (of combustion) are being used. Duration of combustion, also “burn duration” is a measure of the burn progress in a combustion cycle, expressed as mass fraction burned during a certain crank angle. For example, the burn duration of Δθ₀₋₁₀% of 15° crank angle means that 10% of the charge mass has burned during 15° crank angle revolution.

The combustion center of gravity indicates the state in which half of the fresh charge is burned. It is also known as MFB50, i.e. 50% mass fraction burned. The terms can be found in textbooks on internal combustion engines, see in particular Heywood, John B., Internal Combustion Engine Fundamentals, New York, McGraw-Hill, 1988.

The center of gravity of combustion influences efficiency of the engine and amount of emissions of the engine.

Particularly preferred is the embodiment, whereby the center of gravity of combustion (when half of the total energy has been released in the combustion) is tuned to 5-7°—after the upper dead center. To determine the center of combustion the crank angle position of the peak firing pressure can be used.

In another preferred embodiment it is foreseen, that to at least one of the cylinders of the internal combustion engine at least two fuels with different auto-ignition properties are supplied.

With respect to gases all numbers given in % relate to volume percentage.

The first fuel can be natural gas or a mixture of natural gas and CO2 such that the total amount of CO2 and CH4 is higher than 80%.

The second fuel can be a fuel having a cetane number between 30 and 70, preferably between 40 and 60. One example is a Diesel fuel.

According to another preferred embodiment it can be foreseen that the one of the at least two fuels, which has the higher tendency to autoignite (normally, this is involves a higher cetane number) is supplied at a later point in time to the at least one cylinder of the internal combustion engine than the fuel which Has a lower tendency to autoignite (normally, this involves the higher octane/methane number).

It should be understood, that the time of injection of the second fuel and the amount of the second fuel which both influence the center of gravity of the combustion should be chosen such that a desired efficiency of the engine can be achieved and amount of emissions and mechanical stress are within an acceptable range. This can be achieved by having the center of gravity of combustion rather early, e. g. 0 to 15° crank angle after firing top dead center (aTDC)

To start with, a broad parameter set is defined. The first fuel is natural gas, the second fuel is diesel. For example:
Second fuel injection timing 180° to 40° BEFORE FIRING TDC
The second fuel acts as an auto-ignition source
Mixture with excess of air and EGR, lambda larger than 1.6 and EGR ranges from 0-40%, either internal or external cooled/uncooled EGR
amount of second fuel 0.1-15% based on energy content (at full load, increase amount of second fuel in part load operation
Mixture temperature at intake of cylinder 50-130° C.

From the above broad parameter set choose an initial set of parameters depending on the type of the given engine (size of engine, rpm of the engine, geometric compression ratio), available types of fuels.

As a second step, premix the chosen first fuel and air to achieve a homogenous combustible mixture at a desired lambda. The combustible mixture should be dilute (lambda should be high) to achieve low NOx emissions. There are different ways this can be done, e. g. by way of a carburetor or a gas mixer or with a port injection valve or with a gas injector directly in the combustion chamber.

Choose specific parameters out of the broad set of parameters and run the engine. Measure efficiency of the engine, amount of emissions (NOx and HC, preferably also CO), center of gravity of combustion and duration of combustion. Center of gravity of combustion and duration of combustion can e. g. be inferred by measuring the time variation of the in-cylinder-pressure. This is known to the skilled person.

If efficiency of the engine and amount of emission is already within a desired range keep the initial set of parameters.

If duration of combustion is too long (i.e. efficiency is too low and/or emissions are too high, in particular HC-emissions), e.g. duration is longer than 20 to 30 degrees crank angle independently of rpm of the engine, increase the temperature of the cylinder charge (e.g. by increasing intake temperature of the mixture and/or increasing residual gases in the cylinder) and/or the amount of second fuel mixed to the combustible mixture keeping in mind that the higher the temperature of the cylinder charge the lesser amount of second fuel is required and vice versa. In order to increase the duration of combustion the temperature of the cylinder charge is decreased by decreasing an internal EGR-rate; to shorten the duration of combustion the temperature of the cylinder charge is increased by increasing an internal EGR-rate. In contrast to a cooled external EGR, the internal EGR is an un-cooled, i.e. “hot” EGR.

Out of economic considerations it might be preferred to keep the amount of second fuel as low as possible (but not so low that the center of gravity of combustion cannot be influenced anymore) and constant and only increase the temperature of the cylinder charge.

Continue to run the engine again with the changed temperature and check duration of combustion with regard to efficiency of the engine and emissions. If duration of combustion is still too long, increase temperature of combustible mixture even more and preferably do not change amount of second fuel (if economic considerations apply).

If duration of combustion is now too short (efficiency and emissions are fine but peak pressure in cylinder is too high and/or pressure rise rate is too steep) decrease the temperature of the cylinder charge and preferably do not change amount of second fuel. Iterate this procedure until duration of combustion is within a desired range. Cylinder peak pressure and pressure gradients are suitable indicators for mechanical stresses to the engine, high peak pressure and large gradients meaning high mechanical load.

A narrower set of parameters could look as follows (first fuel is natural gas, second fuel is diesel):
Second fuel injection timing 80° to 60° BEFORE FIRING TDC
The second fuel acts as an auto-ignition source
Mixture with excess of air and EGR, lambda between 2.3 and 2.6 or 2.6 and 2.9, and internal EGR ranges from 3-20%,
amount of second fuel (e. g. Diesel) 1-7% based on energy content
Mixture temperature at intake of cylinder 70-100° C.

A specific example looks as follows (first fuel is natural gas, second fuel is diesel):
second fuel injection timing 70° BEFORE FIRING TDC
The second fuel acts as an auto-ignition source
Mixture with excess of air and EGR, lambda equal 2.4 and internal EGR 10%,
amount of second fuel (e. g. Diesel) 5% based on energy content
Mixture temperature at intake of cylinder 75° C.

It is preferred that
the brake mean effective pressure is between 14 and 26 bar,
the compression ratio is between 10 and 14 and
the intake valve closing at 1 millimeter lift is between 30 degrees before bottom dead center and 30 degrees after bottom dead center during the intake stroke.

The invention will be further discussed with respect to the figures. With respect to the figures, Diesel will be discussed as the second fuel by way of example.

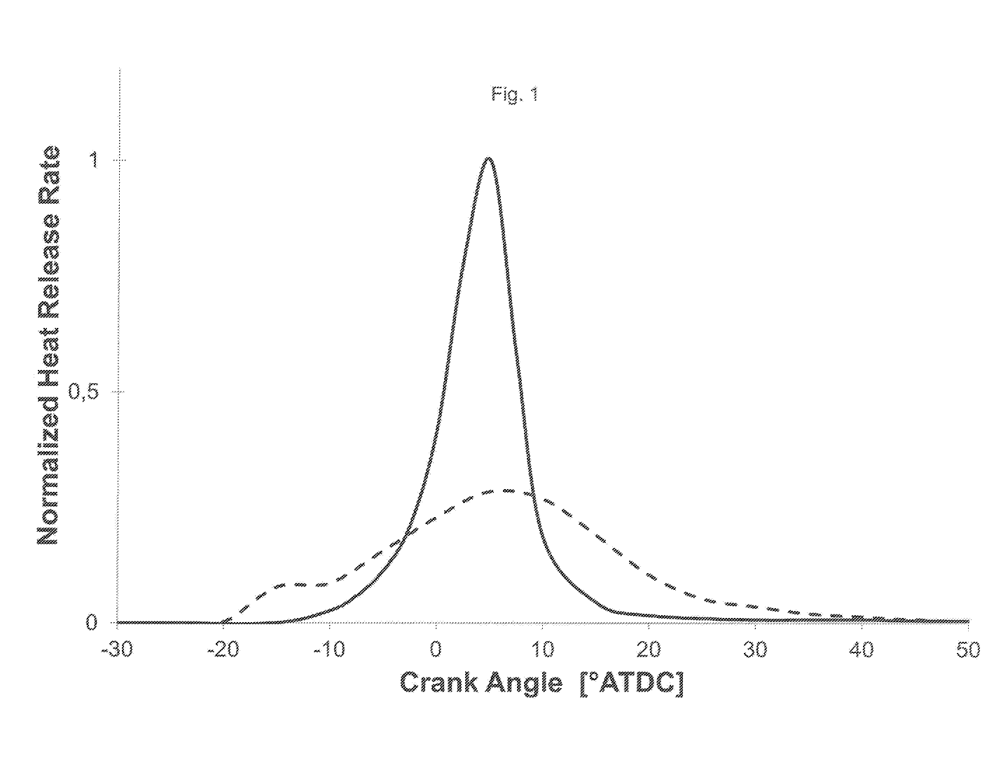

FIG. 1 shows the normalized heat release rate plotted against the crank angle for state of the art combustion compared to the present invention

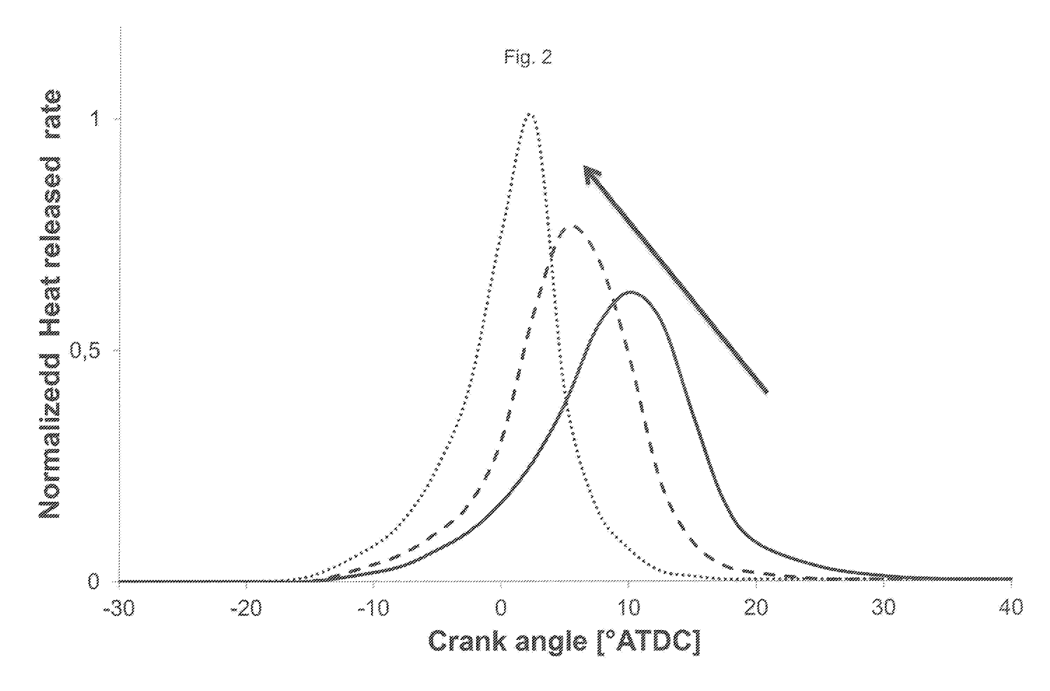

FIG. 2 shows the effect of increasing internal EGR, Diesel amount or charge temperature or retarding injection time on the combustion for the invention,

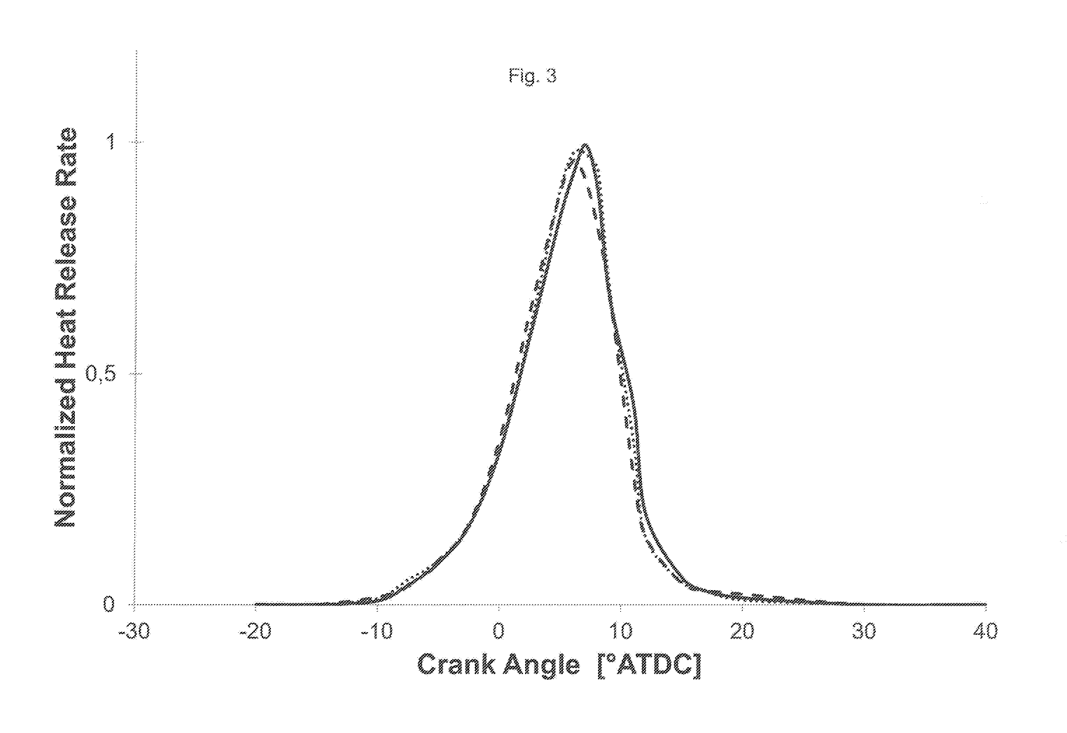

FIG. 3 shows the compensation of counteracting changes caused by one parameter by changing another parameter in the opposite way

Referring to FIG. 1, it shows the normalized heat release rate plotted against the crank angle in degrees after top dead center (ATDC). Negative values of course mean that the event is before firing TDC. The heat release rate has been explained before. It is a measure for the combustion characteristics. The dotted line represents the normalized heat release rate for combustion in a standard gas engine. The solid line represents the normalized heat release as achieved by the present invention. It can be seen, that the combustion event achieved by the present invention is narrower and more centered at TDC than the state of the art combustion.

FIG. 2 schematically shows the effect of increasing internal EGR or Diesel amount or charge temperature or retarding injection time on the combustion for the invention. The arrow indicates how the combustion is reacting to the respective increase of the mentioned variables EGR, Diesel amount or charge temperature, or a retardation of injection time of the second fuel, respectively. It can be seen that increasing internal EGR, charge temperature or Diesel amount, or injecting the second fuel later increases the combustion speed and shifts the combustion phasing earlier. Only one of the parameters (internal EGR, intake temperature or Diesel amount) has been changed at the same time while the other two parameters stayed the same. Although the individual effect for each of these measures is of course different quantitatively, the qualitative trend is the same.

Referring to FIG. 3, two of the four parameters have been changed, but in the opposite direction to achieve the same combustion position, thus compensating for the individual changes. E. g., when increasing the internal EGR amount, Diesel amount or intake temperature (or both) would have to be reduced in order to have the same combustion position. The solid, the dotted and the dashed lines refer to the same set of parameters; the figure shows that through changing individual parameters one can tune the combustion event to the same position.

1. A method for operating a compression ignition engine, the engine having at least one cylinder and a piston moveable in the at least one cylinder, and the method comprising the steps of:
forming a combustible mixture by mixing generally homogeneously a first fuel and air and introducing this mixture into the at least one cylinder
compressing the combustible mixture with the piston in a compression stroke
during the compression stroke but before start of combustion adding a second fuel to the combustible mixture, thus creating a cylinder charge, the second fuel being easier to autoignite than the first fuel
continuing the compression stroke until combustion starts at those locations in the cylinder where concentration of the second fuel and/or temperature of the mixture is highest,
wherein a temperature of the cylinder charge, or the amount of second fuel added to the combustible mixture or a combination of both is being chosen such that a desired duration of combustion can be achieved.

2. Method according to claim 1, wherein the first fuel is natural gas or a mixture of natural gas and CO2 such that the amount of CO2 and CH4 is higher than 80%.

3. Method according to claim 1, wherein the second fuel has a cetane number between 30 and 70, preferably between 40 and 60.

4. Method according to claim 1, wherein the second fuel is supplied at a later point in time to the at least one cylinder of the internal combustion engine than the first fuel.

5. Method according to claim 1, wherein the in-cylinder temperature is controlled either by an internal EGR-rate kept in the combustion chamber during gas exchange process, or by an external EGR rate recirculated in the intake system.

6. Method according to claim 1, wherein the injection time of the fuel being easier to auto-ignite is chosen between 180° to 40° BEFORE FIRING TDC, a lambda value of larger than 1.6, an EGR rate between 0-40%, the amount of fuel being easier to autoignite is chosen between 0.1% to 15% with respect to the energy content of the charge, the mixture temperature at intake of cylinder is chosen between 50-130° C.

7. Method according to claim 1, wherein the injection time of the fuel being easier to auto-ignite is chosen between 80° to 60° BEFORE FIRING TDC, a lambda value between 1.8 and 2.3, an internal EGR rate between 3-20%, the amount of fuel being easier to autoignite is chosen between 1% to 7% with respect to the energy content of the charge, the mixture temperature at intake of cylinder is chosen between 70-100° C.

8. Method according to claim 1, wherein
the injection time of the fuel being easier to auto-ignite is chosen between 80° to 60° BEFORE FIRING TDC,
a lambda value between 2.3 and 2.6 or 2.6 and 2.9 or 2.3 and 2.9,
an internal EGR rate between 3-20%,
the amount of fuel being easier to autoignite is chosen between 1% to 7% with respect to the energy content of the charge,
the mixture temperature at intake of cylinder is chosen between 70-100° C.

9. Method according to claim 7, wherein
the brake mean effective pressure is between 14 and 26 bar,
the compression ratio is between 10 and 14 and
the intake valve closing at 1 millimeter lift is between 30 degrees before bottom dead center and 30 degrees after bottom dead center during the intake stroke.

10. A compression ignition engine, the engine having at least one cylinder and a piston moveable in the at least one cylinder, and an injector to inject the second fuel, having an electronic control unit configured to operate according to a method according to claim 1.
